(19) United States
(12) Patent Application Publication
(10) Pub. No.: US 2026/0259668 A1
(43) Pub. Date: Sep. 3, 2026

(54) SECURING NON-VOLATILE MEMORY BY RESTRICTING DATA WIDTH AND ELIMINATING DIRECT READBACKS

(71) Applicant: CRYPTOGRAPHY RESEARCH, INC., San Jose, CA (US)

(72) Inventor: Scott C. Best, Palo Alto, CA (US)

(21) Appl. No.: 19/215,157

(22) Filed: May 21, 2025

Related U.S. Application Data
(60) Provisional application No. 63/765,491, filed on Feb. 28, 2025.

(51) Int. Cl. G06F 3/06

(52) U.S. Cl. CPC G06F 3/0622; G06F 3/0637; G06F 3/0679

(57) ABSTRACT

Disclosed systems and techniques involve securing secret data in authentication integrated circuits by implementing one or more data access barriers within memory arbitration circuitry. An arbiter circuit may control access to a non-volatile memory containing both secret and public data regions based on lifecycle states. A first security barrier may eliminate direct readback of secret data by computing non-invertible function outputs from requested data during manufacturing states. A second security barrier may restrict data width for public data regions and interfaces, limiting access to only a fraction of the full memory width used for secret data. These techniques can prevent unauthorized extraction of sensitive information even if address manipulation attacks are attempted, without requiring additional dedicated memory macros.

### RELATED APPLICATION

This application claims the benefit of U.S. Provisional Application No. 63/765,491, filed February 28, 2025, titled “Implementation of A Secure NVM System,” the entire contents of which are hereby incorporated by reference.

### TECHNICAL FIELD

The instant disclosure pertains to security mechanisms in hardware authentication systems and, more specifically, to techniques for protecting sensitive data in non-volatile memory through specialized data path configurations and access control methods.

### BRIEF DESCRIPTION OF THE DRAWINGS

The present disclosure will be understood more fully from the detailed description given below and from the accompanying drawings of various implementations of the disclosure.

FIG. 1 is a block diagram illustrating an example system architecture in which implementations of the present disclosure may operate.

FIG. 2A illustrates an example architecture of an arbiter capable of protecting secret data in a non-volatile memory (NVM) of an authentication integrated circuit (IC), in accordance with some implementations of the present disclosure.

FIG. 2B illustrates an additional implementation of the arbiter architecture for dual-port, dual-width NVM configurations), in accordance with some implementations of the present disclosure.

FIG. 3 is a flow diagram of an example method of protecting secret data in a non-volatile memory (NVM) of an authentication integrated circuit (IC), in accordance with some implementations of the present disclosure.

FIG. 4 is a flow diagram of another example method of protecting secret data in a non-volatile memory (NVM) of an authentication integrated circuit (IC), in accordance with some implementations of the present disclosure.

FIG. 5 depicts a block diagram of an example computer system operating in accordance with one or more aspects of the present disclosure.

### DETAILED DESCRIPTION

Aspects of the present disclosure are directed to secure non-volatile memory (NVM) configuration and arbitration in authentication integrated circuits (ICs). In various security critical applications, such as anti-counterfeiting systems for printer cartridges, rechargeable batteries, medical devices, and other high volume consumer products, authentication ICs can be used to protect secret data from unauthorized access while maintaining low cost due to the high production volumes and price sensitivity of the protected products. Authentication ICs typically store secrets in three ways: (1) netlist secrets, including constants baked into logic, hardware algorithms, and sea of gates code; (2) data generated by on-chip Physical Unclonable Function (PUF) circuits; and (3) secret data provisioned into on-chip NVM or eFuse. Each of these storage methods presents different attack surfaces that require specific countermeasures.

For secret data stored in NVM, authentication ICs typically employ a limited number of independent NVM macros due to cost constraints. The NVM macros can include a lightweight eFuse block that may be used for recording a small number of configuration bits (e.g., the lifecycle state of the device) plus a separate, larger NVM macro whose address space may be divided between secret and public data regions. This shared NVM configuration can create security vulnerabilities that attackers can exploit to extract sensitive information.

In conventional authentication IC designs, an arbiter circuit controls access to both secret and public data regions of the NVM based on the device's lifecycle state, which may be stored in eFuse memory. During early manufacturing lifecycles, the arbiter permits writing and reading of data in the secret region for provisioning (e.g., key loading) purposes. Once the device transitions to the fielded, operational lifecycle (sometimes referred to as mission mode), the arbiter blocks external read access to the secret data region while maintaining read access for the internal security core. This architecture, however, is vulnerable to two primary attack vectors. First, attackers may manipulate the lifecycle information through techniques, such as voltage glitching or Focused Ion Beam (FIB) modification to trick the arbiter into operating in manufacturing mode, thus enabling unauthorized readback of secret data. Second, attackers may physically modify address lines between the arbiter and NVM (e.g., the address lines that distinguish between secret and public regions) to redirect public data access requests to secret data regions, effectively bypassing the arbiter's access controls.

The present disclosure addresses these vulnerabilities through two complementary techniques that may be implemented independently or in combination. The first technique eliminates the direct readback path used during provisioning by replacing it with a non-invertible function, such as a Cyclic Redundancy Check (CRC) or cryptographic hash. During manufacturing verification, instead of allowing direct readback of secret data (which is usually allowed to confirm that provisioned data was correctly stored within the NVM memory), the arbiter may provide only a CRC or hash value computed from the secret data. This can allow manufacturers to verify that data was correctly written without exposing the actual data, thereby preventing successful extraction of secrets even if an attacker manipulates the lifecycle controls.

The second technique reduces the data width of both the public data regions in the NVM and the public data interface paths. Specifically, while secret data is stored at the full native width of the NVM macro (e.g., 32 bits), public data is stored and accessed at a reduced width (e.g., 8 bits). The physical interface for public data is limited to this reduced width, creating a hardware barrier that prevents extraction of full width secret data through the public interface. Even if an attacker successfully redirects a public data access to the secret region, they can only extract a fraction of the data (e.g., 8 bits of a 32- bit secret), requiring significantly more complex attacks to obtain complete secrets.

For provisioning of secret data through the narrow public interface, the system can include a write buffer that accumulates multiple narrow width writes before performing a full width write to the NVM. This can allow manufacturers to write full- width secret data while maintaining the security benefits of the reduced width public interface. In some implementations, the arbiter includes a command scheduler that arbitrates between simultaneous access requests from multiple sources and enforces access control based on the device's lifecycle state. The arbiter may further include routing logic that directs full width data to and from the security core while restricting external interfaces to the reduced width.

These techniques significantly increase the complexity and cost for adversaries attempting to extract secret data from an NVM macro, as they must now develop more sophisticated attacks that target a relatively larger number of signals rather than a small number of address lines. The disclosed methods can eliminate low cost, low risk approaches that would otherwise compromise the security of the authentication system.

Various implementations and modifications of these and other NVM security techniques that enable protection of secret data in authentication ICs are contemplated. The advantages of the disclosed implementations include but are not limited to enhanced security for anti-counterfeiting solutions while maintaining the cost effectiveness required for high volume production.

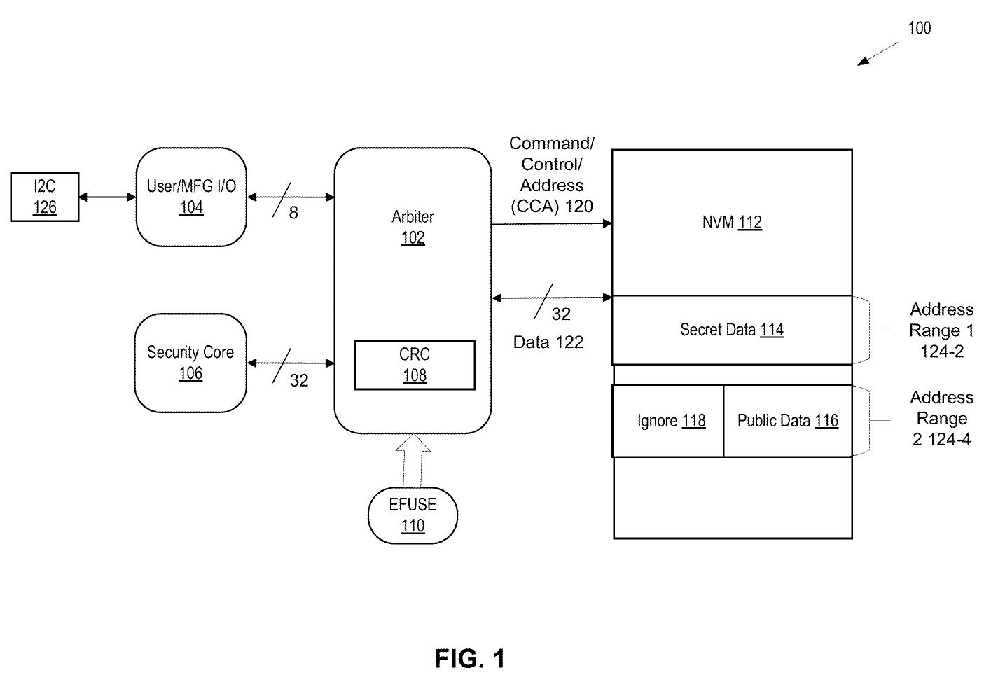

FIG. 1 is a block diagram illustrating an example system 100 in which implementations of the present disclosure may operate. The system 100 can be implemented in authentication integrated circuits (ICs) used for anti-counterfeiting applications in products, such as printer cartridges, rechargeable batteries, medical devices, and other high-volume cost-sensitive consumer products. Components shown in FIG. 1 may be elements of a single authentication IC.

The system 100 may include an Inter-Integrated Circuit (I2C) interface 126, which can provide a standardized communication protocol for connecting the authentication IC to external systems. A user/manufacturing input/output (I/O) component 104 may serve as the interface between external devices and the authentication IC, allowing data to be read from or written to the IC during both manufacturing and normal operation.

An arbiter 102 can control access to non-volatile memory (NVM) 112 based on the system's lifecycle state. Such arbitration may be used to administer access to different memory regions within the same NVM. During early lifecycle states, the arbiter may allow the user/manufacturing I/O 104 to have read/write access to secret memory regions for provisioning purposes. After the device transitions to mission-mode lifecycle states, the arbiter can change its behavior to restrict the user/manufacturing I/O 104 to only access public memory regions, while allowing only a security core 106 to read from secret regions. The arbiter 102 may include a cyclic redundancy check (CRC) engine 108 that can compute non-invertible function outputs from secret data rather than allowing direct readback.

The security core 106 can be a component that needs access to secret data to perform authentication operations. This component may implement various cryptographic functions and algorithms required for secure authentication.

An eFuse 110 can store the lifecycle state of the authentication IC in a tamper- resistant manner. As a low-cost, electrical fuse memory element, the eFuse 110 may be used to record the device's transitions through various lifecycle stages from manufacturing to operational mode. Unlike other non-volatile memory types (e.g., embedded Flash, EEPROM, one-time programmable (OTP) anti-fuse) eFuse has no high- level protocol associated with it, making it ideal for storing lifecycle information that may need to be accessible at power-on.

The NVM 112 may be implemented using various technologies, such as electrically erasable programmable read-only memory (EEPROM), flash memory, one- time programmable (OTP) anti-fuse memory, or other non-volatile memory types capable of retaining data when power is removed. The NVM 112 can store both secret data 114 and public data 116. The secret data region 114 may contain cryptographic keys and other sensitive information, while the public data region 116 can store information that external devices need to access, such as device IDs or usage counters. Due to cost constraints, secret and public data may share the same physical NVM macro, with different address ranges (124-2 and 124-4) designating different types of data. This arbitrated approach to multiple memory regions within the same NVM is straightforward and relatively low-cost but can be vulnerable to attack without additional protection. The portion labeled ignore 118 represents unused bits in the NVM when using reduced data width for public data. Access to the NVM 112 may be controlled through command/control/address (CCA) signals 120 and data signals 122, which can be managed by the arbiter 102.

The system 100 can address two critical security vulnerabilities. First, attackers may manipulate the lifecycle information in eFuse 110 through voltage glitching or physical modification to trick the arbiter into operating in manufacturing mode, enabling unauthorized readback of secret data. Second, attackers may physically modify address lines in the CCA signals 120 to redirect public data access requests to secret data regions. The system 100 can solve these vulnerabilities through two complementary techniques. To address the first vulnerability, the CRC engine 108 can replace direct readback of secret data with a non-invertible function output, allowing verification of provisioned NVM contents without exposing actual secrets. For the second vulnerability, the data paths for public data access through the user/manufacturing I/O 104 can be limited to a narrower width (e.g., 8 bits) than the NVM's native width (e.g., 32 bits), creating a physical barrier that prevents extraction of complete secrets even if address manipulation succeeds. These techniques may be implemented independently or in combination, providing enhanced security while maintaining the cost-effectiveness required for high-volume production.

When implementing both techniques in combination, the system 100 can operate with the following security enhancements. During manufacturing lifecycle states, any attempt to read from the secret data region 114 through the user/manufacturing I/O 104 can trigger the CRC engine 108 to compute a non-invertible function output rather than providing the actual secret data. Concurrently, all data paths from the user/manufacturing I/O 104 to the NVM 112 can be constrained to a reduced width (e.g., 8 bits) compared to the native NVM width (e.g., 32 bits). In this combined implementation, even if an attacker successfully manipulates the lifecycle state in eFuse 110 to gain manufacturing mode access, they will only receive a CRC or hash value rather than actual secret data. Furthermore, if the attacker attempts to bypass this protection by manipulating address lines to redirect the read access from a public data access to the secret region, they will be limited to extracting only a fraction (e.g., 8 bits) of any 32-bit secret word, necessitating different and more complex attacks to extract complete secrets.

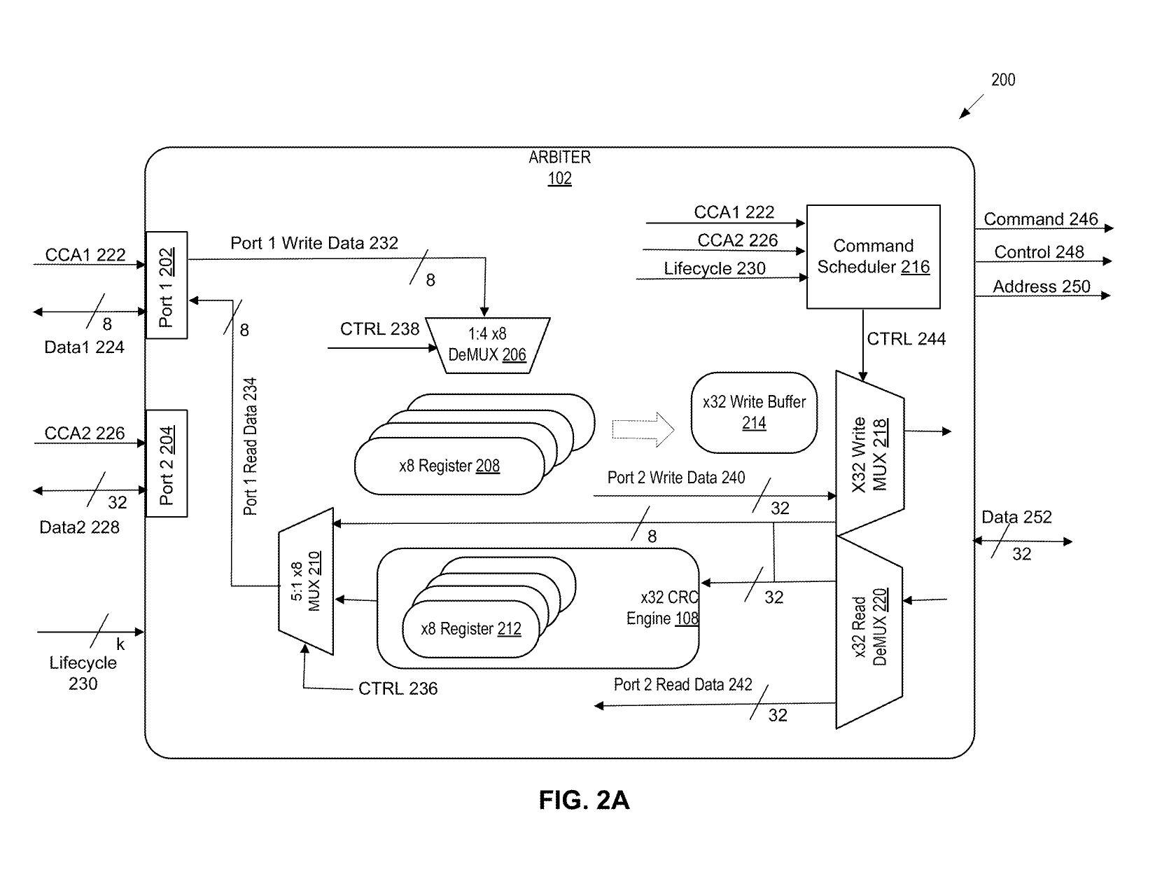

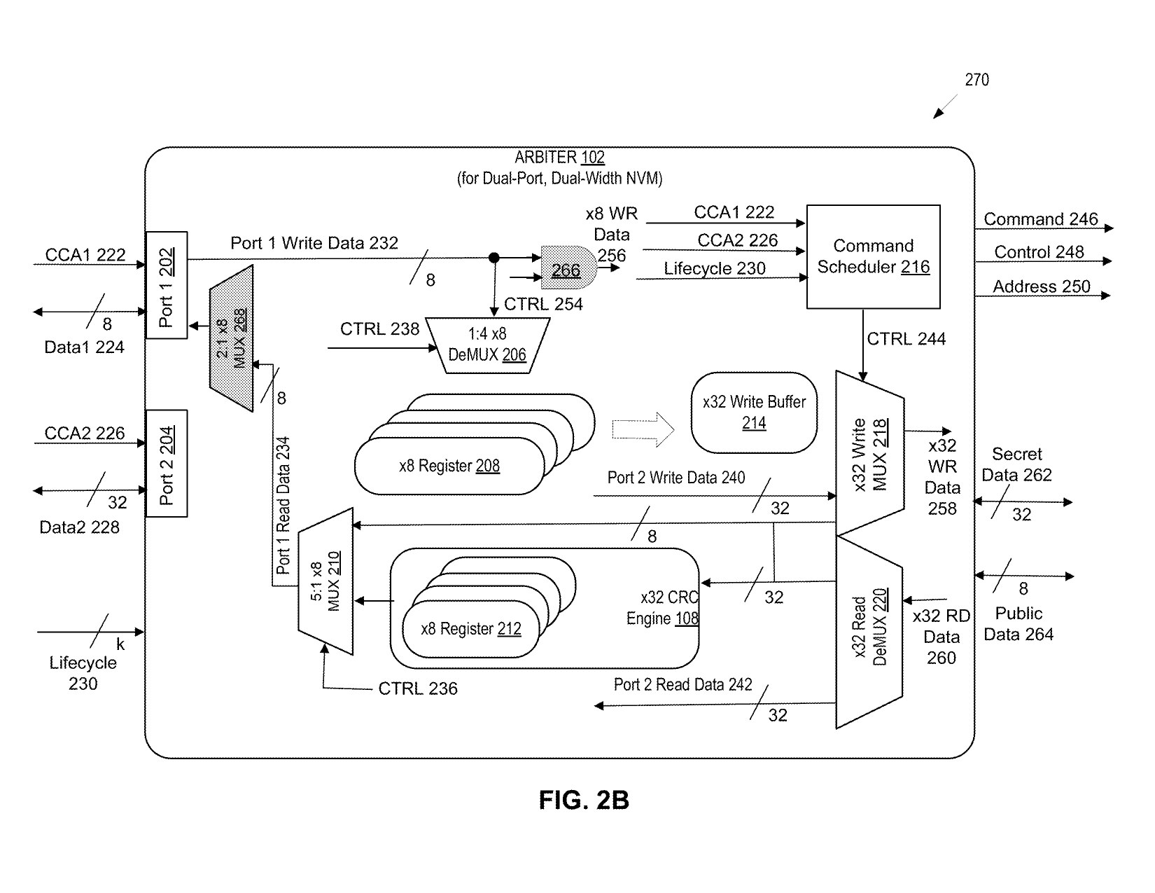

FIG. 2A depicts an example architecture 200 of the arbiter for controlling access to non-volatile memory, in accordance with some implementations. An NVM arbiter with multiple input ports is a common circuit known to those skilled in the art, as it is often required when multiple on-chip subsystems seek to share a common NVM resource. The two-port arbiter 102 can include port 1 202 and port 2 204 interfaces. Port 1 202 may connect to the user/manufacturing I/O 104, while port 2 204 may connect to the security core 106, which may need access to secret data for authentication operations. Port 1 202 may process M-bit data paths (data1 224), while port 2 204 may handle N bit data paths (data2 228). The techniques described herein can be effective when M is substantially smaller than N; in the embodiment shown, M is shown as 8 bits, while N is shown as 32 bits. This design can allow the security core to have full-width access (e.g., 32 bits) to the NVM, while limiting external access to a narrower data path (e.g., 8 bits).

The arbiter 102 may include a command scheduler 216 that processes and arbitrates between different command inputs (CCA1 222 from port 1 202 and CCA2 226 from port 2 204) based on lifecycle state 230 (e.g., a lifecycle state from eFuse 110). CCA1 222 represents the command/control/address signals from port 1 (user/manufacturing interface). These signals may carry external requests to the arbiter 102. For example, a CCA1 signal might contain a command to read a device ID from the public data region, along with the specific address where that ID is stored. During manufacturing, CCA1 might carry a command to provision a secret key, with control bits indicating that verification is required. CCA2 226 represents the command/control/address signals from Port 2 (security core). These signals may carry internal authentication-related requests. For example, CCA2 might contain a command to read a cryptographic key from the secret data region, with control bits specifying which key is needed, and the address where that key may be stored. Lifecycle 230 can include k-bits of lifecycle state information from the eFuse 110. These bits may define the current operational state of the authentication IC. For example, a lifecycle value of 0000 might indicate a blank state where Port 1 write programming and read-back CRC are allowed to the secret-data region, 0001 might indicate a provisioning mode where Port 1 write programming is not allowed but read-back CRC is allowed to the secret-data region, and 0011 might indicate mission mode where no Port 1 read or write access to the secret-data region is permitted at all.

A 1:4 demultiplexer (DeMUX) 206 can direct incoming 8-bit port 1 write data 232 values into one of four 8-bit (x8) registers 208. These four registers may feed into a 32-bit (x32) write buffer 214 that enables full-width writes to memory. This write-buffer architecture can allow port 1 with its limited 8-bit width to still provision full 32-bit secret data during manufacturing by accumulating multiple 8-bit writes before performing a single 32-bit write to the NVM. As mentioned above, other N and M bit values (other than M=8 and N=32) can be supported in a similar manner. The write buffer functionality may be enabled during early lifecycle states when provisioning is allowed. Port 2 write data 240 may be performed at the full data width (e.g., 32-bits). The write buffer operation can create a bridge between the 8-bit external interface and the 32- bit NVM. During a write operation from port 1, the 1:4 DeMUX 206 can sequentially direct each incoming 8-bit value to one of the four x8 registers 208, under the control of CTRL 238. After the four registers are filled (accumulating a complete 32-bit word), the x32 write buffer 214 can assemble these values into the correct byte order and present the complete 32-bit word to the x32 write MUX 218. When CTRL 244 selects this path, the complete word may be written to the NVM 112 in a single operation. This buffering mechanism can allow provisioning of full-width secret data during manufacturing while maintaining the security benefits of the 8-bit restricted interface. The write buffer may perform width conversion without compromising performance or security.

Port 2 write operations may occur via port 2 write data 240, which can deliver 32-bit data directly to the x32 write MUX 218. Unlike port 1 operations, no buffering or accumulation may be needed since the security core 106 can communicate at the full 32- bit width matching the NVM's native width. After the command scheduler 216 determines that a port 2 write should proceed, it may set CTRL 244 to select the port 2 write data path, directing the full 32-bit word to the NVM 112 via data signals 252. This direct path may allow efficient, full width writes without the security restrictions imposed on the external interface.

For read operations via port 1 202, the x32 CRC engine 108 can process 32- bit data from an x32 read de-multiplexer (DeMUX) 220 using 8-bit (x8) register 212. The CRC output may then be output through a 5:1 x8 multiplexer (MUX) 210, as 8-bit port 1 read data 234. The 5:1 x8 MUX 210 may be a multiplexer that selects one of five possible 8-bit inputs to be routed to the port 1 read data 234 output. The 5:1 indicates the MUX has five input channels and x8 indicates the MUX is 8 bits wide. Four channels may be used for reading the four 8-bit segments of a 32-bit word from the NVM. Since the public interface is limited to 8 bits, but the NVM operates at 32 bits, a full 32-bit word may be broken into four 8-bit elements. These four channels may allow sequential access to each 8-bit portion of the 32-bit CRC value. The fifth channel may be used for reading 8-bits of public data from the NVM macro. During manufacturing operations when verification of written secret data is needed, the CRC engine 108 may produce a 32-bit CRC value that may be sent through the user manufacturing I/O path using the four 8-bit registers 212. The fifth channel may provide the route for 8-bit public data to reach port 1. The 5:1 x8 MUX 210 therefore allows the arbiter 102 to select between either one 8-bit segment of data from a 32-bit read from public data regions (where "N - M" bits, e.g. 24 bits, delivered from the NVM are ignored) or the 32-bit CRC value (stored in four 8-bit registers 212) calculated from secret data region verification.

For read operations initiated by the security core 106, the x32 read DeMUX 220 may receive the full 32-bit data word from the NVM 112 and, based on CTRL 244 from the command scheduler 216, route this data to port 2 read data 242. This path can maintain the full 32-bit width throughout the operation, allowing the security core 106 to efficiently access both secret and public data regions at maximum throughput. The security core 106 can directly receive unmodified 32-bit data because it operates within the secure boundary of the authentication IC and is trusted with access to secret data.

The command scheduler 216 can provide control signals (e.g., CTRL 236, CTRL 238, CTRL 244) that manage data flow between components. The control signal CTRL 236 may be used to manage the operations of the 5:1 x8 MUX 210. The signal may determine which of the five possible input channels should be selected for output to port 1 read data 234. The command scheduler 216 may set this control based on lifecycle state (e.g., manufacturing or mission-mode), which port (1 or 2) initiated the read command, and whether normal data or CRC data needs to be provided. The control signal CTRL 238 may direct the operation of the 1:4 x8 DeMUX 206 used during write operations. It may determine which of the four 8-bit registers should receive the current 8-bit input from the port 1 write data 232. By cycling through all four registers, the system can accumulate four 8-bit writes to form a complete 32-bit word before writing to the NVM. The control signal CTRL 244 may manage the operation of both the x32 write MUX 218 and x32 read DeMUX 220. The control signal may determine, for writes, whether data from port 1 (via the write buffer) or port 2 should be written to the NVM. For reads, the control signal may determine whether data from the NVM should be routed to port 1 or port 2. The command scheduler 216 may generate these control signals based on the current lifecycle state (from lifecycle input 230), the command inputs (CCA1 222 and CCA2 226), arbitration decisions (which port has priority), and/or security policy rules (e.g., whether secret data can be accessed from port 1).

The arbiter 102 may (e.g., via the command scheduler 216) output appropriate command 246, control 248, and address 250 signals to the NVM 112, and/ receive data 252 (e.g., 32-bit data) from the NVM 112. Command 246 represents the operation instruction sent to the NVM. Examples can include read (retrieve data from a specified address), write (store data at a specified address, erase (clear data at a specified address), and verify (perform a verification operation). Control 248 can include additional parameters for the command execution. Examples can include byte-enable signals for partial-word operations, mode selection bits (e.g., burst mode, single operation), timing parameters, and power-saving model indicators. Address 250 can specify the memory location for the operation. For example, 0x0000-0x7FFF may refer to addresses in the secret data region (address range 1) and 0x8000-0xFFFF may refer to addresses in the public data region (address range 2).

FIG. 2B illustrates an additional implementation of the arbiter architecture 270 for dual-port, dual-width NVM configurations, in accordance with some implementations of the present disclosure. FIG. 2B shows the same core components as in FIG. 2A, with modifications to support direct interfacing with a dual-port NVM.

This implementation includes an x8 WR Data output 266 that connects directly to the NVM's narrow port. This can allow port 1 202 to write M-bit data directly to the NVM through a dedicated path (where M=8 in this example), while still supporting the accumulation of M-bit writes into N-bit words (where N=32 in this example) via the x32 write buffer 214 when needed for writing into the secret-data region.

CTRL 254 represents a control signal that can manage the direct 8-bit write path, determining when data should be written directly through the narrow port versus when it should be accumulated in the write buffer.

The arbiter 102 can maintain separate paths for x32 WR Data 258 (connecting to the NVM's wide port for secret data) and x32 RD Data 260 (receiving 32-bit data from the NVM). Similarly, separate paths may exist for public data through the 8-bit interface (x8 WR Data 266 and the 8-bit connection to public data 264). The secret data 262 represents the 32-bit data path to the secret data region of the NVM, while public data 264 represents the 8-bit data path to the public data region. This physical separation of paths reinforces the security barrier between secret and public data. MUX 256 is an additional multiplexer that can select between direct 8-bit writes and the regular port 1 write data 232 path, providing flexibility in how data is routed to the NVM's narrow port.

An advantage of this dual-port, dual-width architecture is that it can eliminate the need to discard bits when storing public data, as each port of the NVM may be physically designed for its respective data width. While a single-port architecture requires storing public data in a subset of bits in a full-width word (wasting capacity), this architecture can utilize memory resources more efficiently by having dedicated ports for each width.

The operation differs from the single-port architecture in that the control signals manage interface selection more than data path routing. The command scheduler 216 can still arbitrate access between ports based on lifecycle state and access permissions, but with less need for complex multiplexing of data paths since data can flow simultaneously through both ports.

Other aspects of operation, including the CRC engine 108, command/control protocols, and security features for preventing unauthorized access to secret data, can remain functionally similar to the architecture described above in reference to FIG. 2A.

When both security techniques are implemented together in either the single- port architecture (FIG. 2A) or dual-port architecture (FIG. 2B), the arbiter 102 can enforce protection through coordinated operation of multiple security features. During manufacturing lifecycle states (determined from lifecycle 230), requests to read from secret data regions can generate non-invertible function outputs (e.g., via the CRC engine 108) rather than returning actual secret data. These CRC outputs can then be provided through the same width-restricted interface (port 1) that enforces the M-bit width limitation for public data access. The command scheduler 216 can coordinate these protections based on the address being accessed and the current lifecycle state, ensuring that both techniques work in concert to protect secret data. In the dual-port architecture of FIG. 2B, the separation of data paths for secret data 262 (at full width) and public data 264 (at reduced width) can reinforce this protection by providing physical isolation between the data paths while still enabling the CRC engine 108 to operate on the full- width secret data.

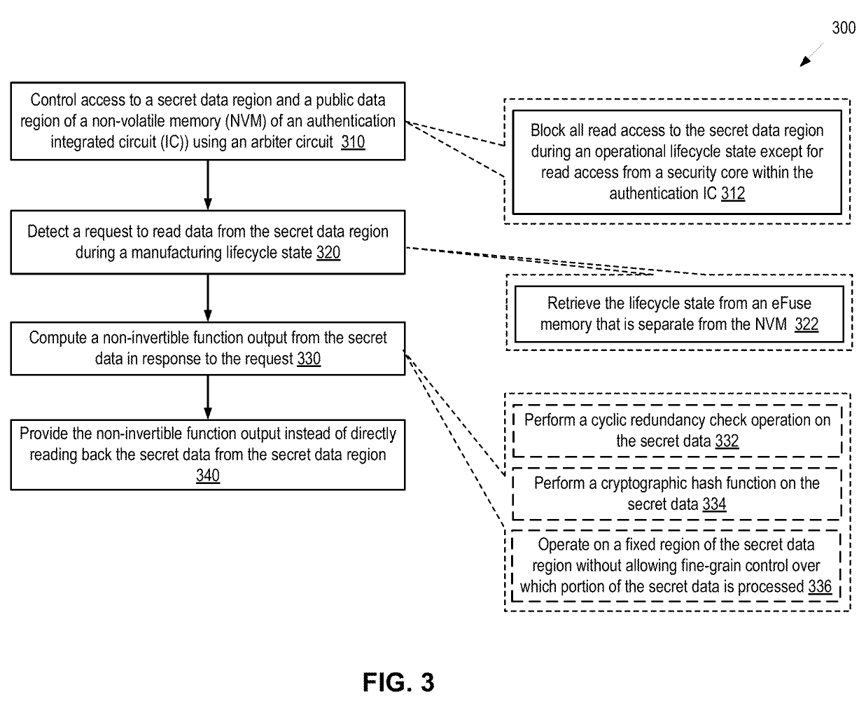

FIG. 3 illustrates a flowchart of an example method 300 for implementing the first security technique (elimination of direct readback), in accordance with some implementations of the present disclosure. The method 300 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 300 is performed by control logic of arbiter 102.

At block 310, the arbiter 102 can control access to a secret data region 114 and a public data region 116 of a non-volatile memory (NVM) 112 of an authentication integrated circuit (IC). In some implementations, at block 312, the arbiter 102 can block all read access to the secret data region 113 during an operational lifecycle state except for read access from the security core 106 within the authentication IC.

At block 320, the arbiter 102 may detect a request to read data from the secret data region 114 during a manufacturing lifecycle state. In some implementations, at block 322, the arbiter 102 may retrieve the lifecycle state from an eFuse 110 that is separate from the NVM 112. This lifecycle state may be manipulated by attackers through voltage glitching or FIB modifications to trick the arbiter into operating in manufacturing mode when it should be in mission mode. This type of attack attempts to "roll back" a mission- mode device to an earlier, less secure lifecycle state when direct readback was allowed.

At block 330, the CRC engine 108 can compute a non-invertible function output from the secret data (from the secret data region 114) in response to the request. This can eliminate direct readback paths that test engineers traditionally use during manufacturing, which can become security vulnerabilities if exploited. In some implementations, at block 332, the CRC engine 108 can perform a cyclic redundancy check operation on the secret data. For example, when reading back key material from a 1 KB secret data region, only a CRC of the entire region may be returned rather than the actual 1KB of secret data In some implementations, at block 334, the arbiter 102 may perform a cryptographic hash non-invertible function on the secret data. In some implementations, at block 336, the CRC engine 108 can operate on a fixed region of the secret data region 114 without allowing fine-grain control over which portion of the secret data is processed. The CRC may be a fixed-size aligned access, such as covering 128 bits and aligned to the start of the first 32-bit word, to prevent attacks where multiple CRCs may be obtained while sliding the read window across the secret data region 114.

At block 340, the arbiter 102 may provide the non-invertible function output instead of directly reading back the secret data from the secret data region 114. This can allow manufacturers to verify that correct data was written without exposing the actual secret data. The testers may perform an additional computation to match the CRC value rather than directly reading the secret.

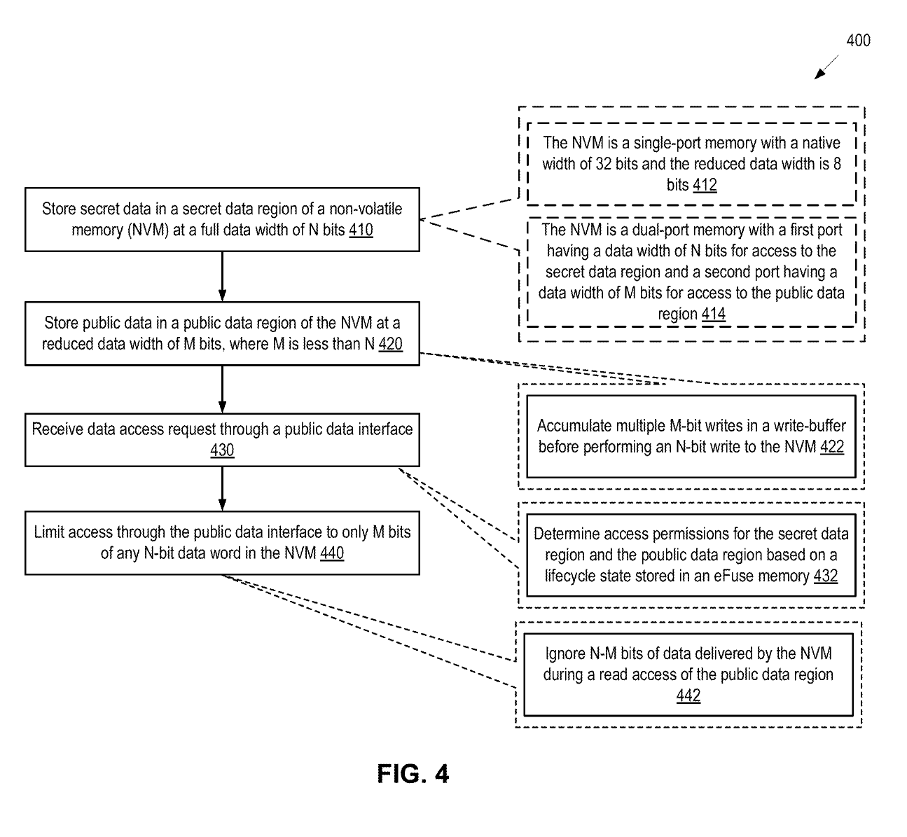

FIG. 4 shows a flowchart of an example method 400 for implementing the second security technique (bit-width reduction), in accordance with some implementations of the present disclosure. The method 400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 400 is performed by control logic of arbiter 102.

At block 410, the arbiter 102 can store secret data in a secret data region 114 of a non-volatile memory (NVM) 112 at a full data width of N bits. In some implementations, at block 412, the NVM 112 can be configured as a single-port memory with a native width of 32 bits and the reduced data width is 8 bits. In some implementations, at block 414, the NVM 112 may be configured as a dual-port memory with a first port having a data width of N bits for access to the secret data region 114 and a second port having a data width of M bits for access to the public data region 116.

At block 420, the arbiter 102 may store public data in a public data region 116 of the NVM 112 at a reduced data width of M bits, where M is less than N. This approach (e.g., using only 8 bits of a 32-bit word for public data) can help create a physical security barrier, trading capacity for enhanced protection.

At block 430, the user/manufacturing I/O 104 can receive data access requests through a public data interface (e.g., port 1202). This can happen when, for example, an external device like a printer needs to read information such as device ID, model number, or usage data from a cartridge. In some implementations, at block 422, the x32 write buffer 214 can accumulate multiple M-bit writes before performing an N-bit write to the NVM (where of course the number of accumulations is typically just the ratio of N to M). In some implementations, at block 432, the arbiter 102 may determine access permissions for the secret data region 114 and the public data region 116 based on a lifecycle state stored in an eFuse memory 110.

At block 440, the arbiter 102 may limit access through the public data interface to only M bits of any N-bit data word in the NVM 112. This physical limit means that even if an adversary modifies the address lines to redirect a public data access to the secret region 114 (e.g., by manipulating the most significant bit that distinguishes between regions), they can extract only a fraction of any secret (e.g., 8 bits of a 32-bit secret), forcing them to develop much more complex attacks to extract complete secrets. While it would be theoretically possible for an adversary to perform multiple FIB operations to recover all the bits, it would be cost-prohibitive to FIB the same data bus multiple times to recover the entire secret, and the risk can be further mitigated by using an even larger ratio between interface width and NVM width, such as a 4-bit user/manufacturing I/O path coupled to a 64-bit NVM macro. In some implementations, at block 442, the arbiter 102 can ignore N-M bits of data delivered by the NVM during a read access of the public data region 116.

In various implementations, M may be one-fourth of N (e.g., 8-bit interface to a 32-bit NVM, or 16-bit interface to a 64-bit NVM), requiring an attacker to perform at least four separate attacks to extract a complete secret. Other implementations may use different ratios, such as where M is one-eighth of N or one-half of N, depending on the specific security requirements and cost constraints of the target application. When combined with the non-invertible function technique, these width restrictions can further enhance security by ensuring that even if an attacker bypasses the CRC protection through sophisticated methods, they will still face the physical width limitation barrier that prevents extraction of complete secrets through a single attack.

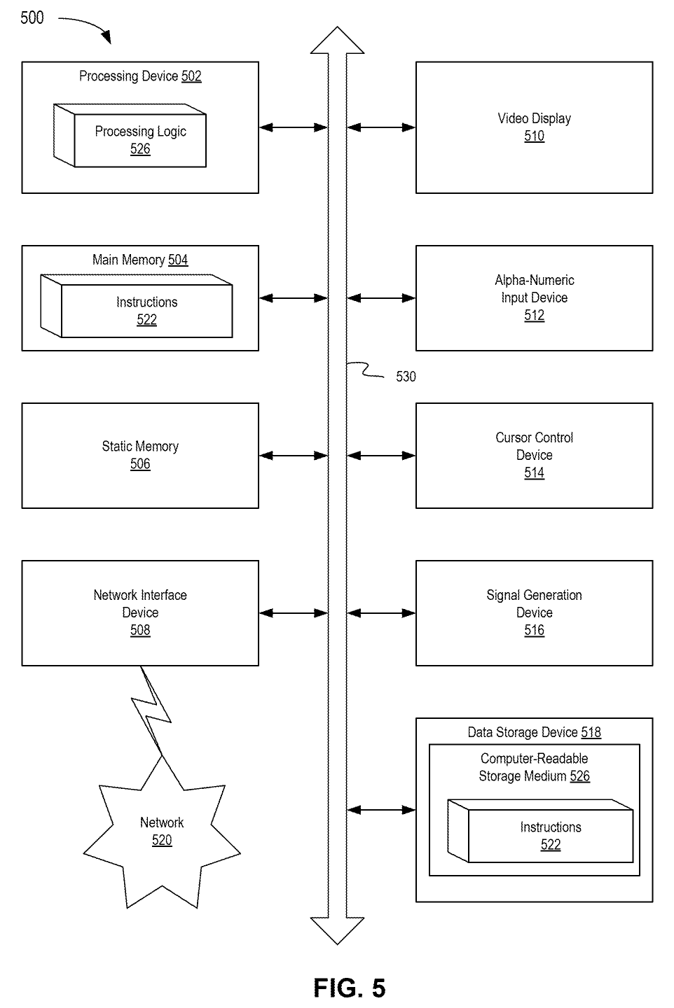

FIG. 5 depicts a block diagram of an example computer system 500 operating in accordance with one or more aspects of the present disclosure. In various illustrative examples, example computer system 500 may include example system 100, illustrated in FIG. 1. Example computer system 500 may be connected to other computer systems in a LAN, an intranet, an extranet, and/or the Internet. Computer system 500 may operate in the capacity of a server in a client-server network environment. Computer system 500 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term "computer" shall also be taken to include any collection of computers that individually or jointly execute a set (or multiple sets) of instructions to perform any one or more of the methods discussed herein.

Example computer system 500 may include a processing device 502 (also referred to as a processor or CPU), a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 518), which may communicate with each other via a bus 530.

Processing device 502 represents one or more general-purpose processing devices such as a microprocessor, central processing unit, or the like. More particularly, processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 502 may be configured to execute instructions implementing method 300 for implementing the elimination of direct readback, and/or method 400 for implementing the bit-width reduction.

Example computer system 500 may further comprise a network interface device 508, which may be communicatively coupled to a network 520. Example computer system 500 may further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 516 (e.g., a speaker).

Data storage device 518 may include a computer-readable storage medium (or, more specifically, a non-transitory computer-readable storage medium) 526 on which is stored one or more sets of executable instructions 522. In accordance with one or more aspects of the present disclosure, executable instructions 522 may comprise executable instructions implementing method 300 for implementing the elimination of direct readback, and/or method 400 for implementing the bit-width reduction.

Executable instructions 522 may also reside, completely or at least partially, within main memory 504 and/or within processing device 502 during execution thereof by example computer system 500, main memory 504 and processing device 502 also constituting computer-readable storage media. Executable instructions 522 may further be transmitted or received over a network via network interface device 608.

While the computer-readable storage medium 526 is shown in FIG. 5 as a single medium, the term "computer-readable storage medium" should be taken to include a single medium or multiple media (e.g., a centralized or distributed database, and/or associated caches and servers) that store the one or more sets of operating instructions. The term "computer-readable storage medium" shall also be taken to include any medium that is capable of storing or encoding a set of instructions for execution by the machine that cause the machine to perform any one or more of the methods described herein. The term "computer-readable storage medium" shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self- consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as "identifying," "determining," "storing," "adjusting," "causing," "returning," "comparing," "creating," "stopping," "loading," "copying," "throwing," "replacing," "performing," or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general-purpose computer system selectively programmed by a computer program stored in the computer system. Such a computer program may be stored in a computer readable storage medium, such as, but not limited to, any type of disk including optical disks, CD-ROMs, and magnetic-optical disks, read- only memories (ROMs), random access memories (RAMs), EPROMs, EEPROMs, magnetic disk storage media, optical storage media, flash memory devices, other type of machine-accessible storage media, or any type of media suitable for storing electronic instructions, cach coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A security system for protecting secret data in a non-volatile memory (NVM) of an authentication integrated circuit (IC), comprising:
the NVM comprising a secret data region and a public data region;
an arbiter circuit coupled to the NVM and configured to control access to the secret data region and the public data region based on a lifecycle state of the authentication IC; and
a non-invertible function circuit coupled to the arbiter circuit;
wherein the arbiter circuit is configured to, during a manufacturing lifecycle state, replace any direct readback of secret data from the secret data region with an output from the non-invertible function circuit, wherein the output is computed based on the secret data to prevent direct extraction of the secret data regardless of the manufacturing lifecycle state.

2. The security system of claim 1, wherein the non-invertible function circuit implements a cyclic redundancy check (CRC) operation.

3. The security system of claim 1, wherein the non-invertible function circuit implements a cryptographic hash function.

4. The security system of claim 1, wherein the non-invertible function circuit is configured to operate on a fixed region of the secret data region without allowing fine-grain control over which portion of the secret data is processed.

5. The security system of claim 1, wherein the lifecycle state is stored in an eFuse memory that is separate from the NVM.

6. The security system of claim 1, wherein the arbiter circuit is further configured to block read access to the secret data region during an operational lifecycle state except for read access from a security core within the authentication IC.

7. A security system for protecting secret data in a non-volatile memory (NVM) of an authentication integrated circuit (IC), comprising:
the NVM comprising a native data width of N bits;
a secret data region in the NVM configured to store secret data at the native data width of N bits;
a public data region in the NVM configured to store public data at a reduced data width of M bits, where M is less than N; and
a public data interface having a maximum data width of M bits to physically limit access to only M bits of any N-bit data word in either the secret data region or the public data region of the NVM when accessed through the public data interface.

8. The security system of claim 7, wherein the NVM comprises a single-port memory with a native data width of 32 bits, and wherein the reduced data width is 8 bits.

9. The security system of claim 7, further comprising a write buffer configured to accumulate multiple M-bit writes before performing an N-bit write to the NVM.

10. The security system of claim 7, wherein the public data interface is configured to ignore N-M bits of data delivered by the NVM during a read access of the public data region.

11. The security system of claim 7, wherein the NVM is a dual-port memory with a first port having a data width of N bits for access to the secret data region and a second port having a data width of M bits for access to the public data region.

12. The security system of claim 7, further comprising an arbiter circuit coupled to the NVM, wherein the arbiter circuit is responsive to a lifecycle state stored in an eFuse memory to determine access permissions for the secret data region and the public data region.

13. A security system for protecting secret data in a non-volatile memory (NVM) of an authentication integrated circuit (IC), comprising:
the NVM comprising a native data width of N bits, with a secret data region and a public data region;
an arbiter circuit coupled to the NVM and configured to control access based on a lifecycle state of the authentication IC;
a non-invertible function circuit coupled to the arbiter circuit; and
a public data interface having a maximum data width of M bits, where M is less than N;
wherein the arbiter circuit is configured to:
during a manufacturing lifecycle state, replace any direct readback of secret data from the secret data region with an output from the non-invertible function circuit, the output computed based on the secret data; and
restrict the public data interface to access only M bits of any N-bit data word in the NVM.

14. The security system of claim 13, wherein the non-invertible function circuit is configured to operate on a fixed region of the secret data region without allowing fine-grain control over which portion of the secret data is processed.

15. The security system of claim 13, wherein M is one-fourth of N.

16. The security system of claim 13, wherein the NVM is a single-port memory and the public data region utilizes only M bits of the N-bit data width.

17. The security system of claim 13, wherein the NVM is a dual-port memory with a first port having a data width of N bits for access to the secret data region and a second port having a data width of M bits for access to the public data region.

18. The security system of claim 13, further comprising a command scheduler configured to arbitrate between simultaneous access requests to the NVM from multiple sources and to enforce access control based on the lifecycle state.

19. The security system of claim 13, further comprising a write buffer configured to accumulate multiple M-bit writes before performing an N-bit write to the secret data region.

20. The security system of claim 13, wherein the non-invertible function circuit implements a cyclic redundancy check (CRC) operation.
